(19) United States
(12) Patent Application Publication
(10) Pub. No.: US 2005/0162713 A1
(43) Pub. Date: Jul. 28, 2005

(54) Image-forming apparatus having a pause function and method thereof

(75) Inventors: Woo-Yeal Song, Suwon-si (KR); Jang-Wook Shim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/033,381

(22) Filed: Jan. 12, 2005

(30) Foreign Application Priority Data
Jan. 27, 2004 (KR) 2004-4899
Apr. 17, 2004 (KR) 2004-26455

(51) Int. Cl. H04N 1/21

(52) U.S. Cl. 358/474

(57) ABSTRACT

Disclosed is an image-forming apparatus having a pause function and a method therefor. The image-forming apparatus having a pause function has an image-scanning unit for moving a loaded document along a transfer path and scanning the loaded document; a pause button for inputting a pause signal requesting to pause the scanning; a control unit for determining whether the pause signal has been input, controlling the image-scanning unit to pause the scanning operations if the pause signal is inputted, and processing a portion of the image scanned until the pause of the scanning operations; and a storage unit for storing the scanned portion of the image.

### CROSS-REFERENCE TO RELATED APPLICATIONS

This application claims benefit under 35 U.S.C. §119(a) from Korean Patent Application Nos. 2004-4899, filed on Jan. 27, 2004; and 2004-26455, filed on Apr. 17, 2004, in the Korean Intellectual Property Office, the entire contents of each are incorporated herein by reference.

### BACKGROUND OF THE INVENTION

1. Field of the Invention

The present invention relates to an image-forming apparatus having a pause function and method therefor. More particularly, the present invention relates to an image-forming apparatus and method therefore capable of partially printing at least one of a plurality of documents by use of a scanning-pause function.

2. Description of the Related Art

In general, the image-scanning unit such as a scanner is a device for reading in graphic form information such as photographs or graphics existing on paper. Such an image-scanning unit is installed for use in facsimile machines, document translation devices, computer-aided design (CAD) computers, character recognition devices, digital photocopiers, and so on.

The image-scanning units are classified into a flat bed-type and a sheet feed-type. The image-scanning unit of the flat bed-type moves an image sensor over a document fixedly loaded on the flat bed to scan the document just like general photocopiers.

On the other hand, the image-scanning unit of sheet feed-type moves each of individual documents over a fixed image sensor to scan the document as in general facsimile machines. Such image-scanning units of sheet feed-type start scanning by use of the image sensor when a document is loaded between the image sensor and white rollers.

General image-scanning units of sheet feed-type such as digital image-forming devices, photocopiers, or the like, have functions enabling one to scan all or only a portion of a document. However, in order to enable one to scan and print such a portion of a document, a display unit is generally needed that can display scanned images. That is, one checks the scanned image on the display unit and chooses a portion of the scanned image, so that the chosen portion of the scanned image is printed.

However, such a partial scanning and printing method needs a separate display unit, for example, a computer, capable of displaying a scanned image, which causes a problem since the method cannot be applied to photocopiers. Further, the conventional partial scanning method is complicated to use.

On the other hand, when scanning a document, the scanning unit of the flat bed-type carries out the scanning operation over the entire scanning section at one time without stopping or pausing. Therefore, a photocopier with the scanning unit of flat bed-type entirely prints only one side of a document after a one-time scanning operation.

If a user wants to print both sides of a document onto one side of a sheet of paper at once, the user can take the methods of, firstly, printing the rear side of a document on the blank portion of a sheet of paper on which the front side of the document has been printed or, secondly, printing the front and rear side of the document on separate sheets of paper respectively, and loading and scanning the sheets of paper together on the flat bed at once.

Such methods are frequently used when one intends to photocopy on one side of a sheet of paper both sides of a resident registration card, an identification card, or the like, or when one intends to photocopy plural documents onto one sheet of paper at the same time.

However, the methods of printing both sides of a document onto one side of a sheet of paper waste users' time and effort and are an inconvenience to users. These methods also unnecessarily waste sheets of paper, and repeatedly use the photocopier for the same copy job since scanning jobs have to be done more than twice.

### SUMMARY OF THE INVENTION

The present invention has been developed in order to solve the above drawbacks and other problems associated with the conventional arrangement. An aspect of the present invention is to provide an image-forming apparatus and method therefor capable of scanning a portion of a loaded document by use of a scanning-pause function before scanning the document from top to bottom, and then printing the scanned portion of the document.

Another aspect of the present invention is to provide an image forming apparatus and method therefore capable of dividing an entire scanning section of a document loaded on a scanning unit of a flat-bed-type into several sections by use of a scanning-pause function before scanning the loaded document, and scanning the divided sections respectively.

The foregoing and other objects and advantages are substantially realized by providing an image-forming apparatus having a partial printing function, comprising an image-scanning unit for moving a loaded document along a transfer path and scanning the loaded document; a pause button for inputting a pause signal requesting to pause the scanning; a control unit for deciding whether the pause signal is input, controlling the image-scanning unit to pause the scanning operations if the pause signal is input, and processing a partial image of the scanned image until the scanning operations are paused; and a storage unit for storing the partial image.

Preferably, the image-forming apparatus further comprises a print unit for printing the partial image. Further, the pause button is preferably provided on an operation panel of the image-forming apparatus.

Preferably, the pause button is provided on the front of the image-forming apparatus so that a user can easily select the button.

Further, the foregoing and other objects and advantages are substantially realized by providing a partial document-printing method for image-forming apparatuses, comprising the steps of moving a loaded document along a document transfer path and scanning the loaded document; deciding whether a pause signal requesting to pause the scanning has been input; pausing the scanning operations if the pause signal has been input; and processing and storing a partially scanned image until the pause signal is input.

Preferably, the partial document-printing method further comprises a step of printing the partially processed image, and the pause signal is input when the pause button is selected.

Preferably, the pause button is provided on an operation panel of the image-forming apparatus.

Further, another aspect of the present invention is achieved by providing an image-forming apparatus having a pause function, comprising a scan unit of flat-bed-type for scanning a document for printout and generating image data; a control unit for controlling the pause and resume commands of the scanning operations of the scan unit and reading of the image data of the scan unit; and a print unit for printing images corresponding to the image data transferred from the control unit.

Preferably, the image-forming apparatus further comprises an input unit for inputting a pause signal requesting to pause the scanning operations of the scan unit and a resume signal requesting to scan the rest of a scanning area, wherein the control unit reads in the pause signal or the resume signal, and controls the scan unit to pause or resume the scanning operations according to the input pause or resume signal.

Preferably, the control unit controls the scan unit to pause at predetermined positions over an entire scanning section, and, if the resume signal is input, controls the scan unit to resume scanning the remaining scanning sections.

Further, the control unit controls more than at least once the scan unit to pause at the predetermined positions over the entire scanning section and resume scanning of the remaining scanning sections after a predetermined period of time lapses.

Preferably, the input unit allows the input of predetermined periods of time for which the scan unit pauses and resumes the scanning operations.

Yet another aspect of the present invention is achieved by providing a scanning method for image-forming apparatuses having a scan unit of flat-bed-type, comprising the steps of pausing scanning operations of the scan unit during scanning; and resuming the scanning operations as a user selects a resume option.

Preferably, pause positions are preset by the user before the scanning operations.

Preferably, pause positions are set by user's selections during the scanning operations.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram for showing an image-forming apparatus having a pause function according to an embodiment of the present invention;

FIG. 2 is a view schematically showing the image-scanning unit of FIG. 1;

FIG. 3 is a view for schematically showing the operation panel of FIG. 1; and

FIG. 4 is a flow chart of the operations of the image-forming apparatus having the partial printing function according to an embodiment of the present invention;

FIG. 5 is a block diagram showing an image-forming apparatus having a pause function according to another embodiment of the present invention;

FIG. 6 is flow chart of the operations of the image-forming apparatus of FIG. 5; and

FIG. 7 is a diagram for explaining scanning operations of the flat bed-type image-forming apparatus by use of a pause function according to an embodiment of the present invention.

### DETAILED DESCRIPTION OF THE PREFERRED EMBODIMENTS

Hereinafter, embodiments of the present invention will be described in detail with reference to the accompanying drawings.

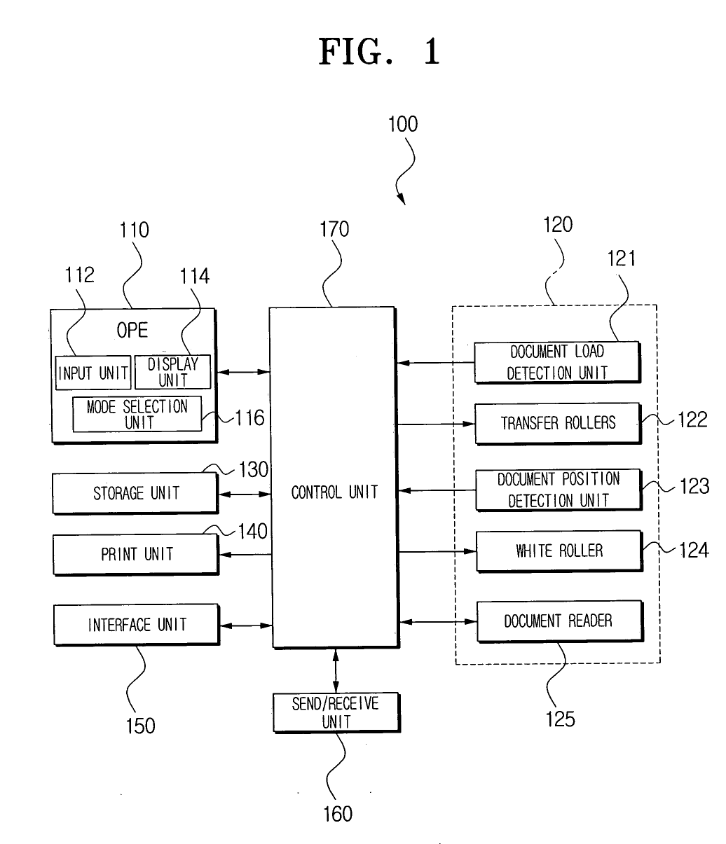

FIG. 1 is a block diagram showing an image-forming apparatus having a pause function according to an embodiment of the present invention.

In FIG. 1, the image forming apparatus 100 according to an embodiment of the present invention has an operation panel (OPE) 110, an image-scanning unit 120, a storage unit 130, a print unit 140, an interface unit 150, a send/receive unit 160, and a control unit 170.

The operation panel 110 preferably has an input unit 112, a display unit 114, and a mode selection unit 116.

The input unit 112 is provided with various function buttons supporting inputs of characters and/or numbers.

The display unit 114 preferably has an LCD panel for displaying the different operation states of the image-forming apparatus 100 under the control of the control unit 170, which will be described in more detail below.

The mode selection unit 116 is a button enabling one to select a photocopy mode, a scan mode, or a send/receive mode to be used for a loaded document.

In detecting the load of at least one or more documents, the image-scanning unit 120 continuously reads and converts the documents into data that the control unit 170 can recognize. The converted data is output to the control unit 170.

The storage unit 130 preferably comprises a non-volatile memory for storing various control programs to operate the image-forming apparatus 100, and a volatile memory for storing data generated during the operations of the image-forming apparatus 100 and detailed information regarding the generated data. For example, the volatile memory stores a scanned document and/or an externally received document for which the current mode set on the operation panel 110 is being carried out.

If a print command is input into the input unit 112 of the operation panel 110, the print unit 140 performs a printing job. For example, if a print command for data read by the image-scanning unit 120 is input, the print unit 140 prints the read data onto sheets of paper under control of the control unit 170.

The interface unit 150 interfaces with an external network to support mutual data communications, and can be a universal serial bus (USB) module, for example. The external network (not shown) refers to any means, such as computers, computer networks, and so on, that can provide data to be printed.

The send/receive unit 160 is a communication module that carries out a function for communicating with external devices (not shown) such as external facsimiles and so on, and, for example, the telephone lines (not shown) and a modem are connected through the Network Control Unit (NCU) (not shown) to carry out the communication functions therebetween.

The send/receive unit 160 sends a document read from the image-scanning unit 120 or a document stored in the storage unit 130 to an external device (not shown), and receives documents from the external devices. The received document is printed by the print unit 140 or sent to an external network (not shown) through the interface unit 150.

If electric power is applied to the image-forming apparatus 100, the control unit 170 controls the overall operations of the image-forming apparatus 100 under a control program stored in the storage unit 130.

In more detail, if a signal selecting the photocopy mode or the scan mode is received from the mode selection unit 116, the control unit 170 controls the image-scanning unit 120 to scan a document.

Further, the control unit 170 controls the scanned document to be stored in a memory, such as RAM, according to a user's selection signal, and controls the print unit 140 to perform printing jobs, or controls the scanned document to be output to an external network through the interface unit 150 or the send/receive unit 160.

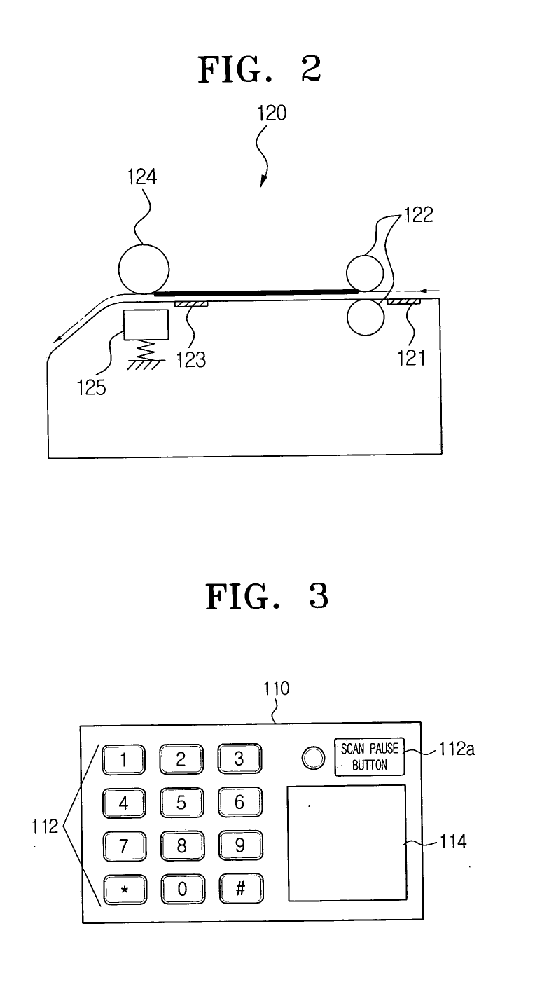

FIG. 2 is a view schematically showing the image-scanning unit of FIG. 1. Like elements and functions shown in FIG. 1 are given like reference numerals, and a detailed description of like elements and functions will not be made.

In FIG. 2, the image-scanning unit 120 has a document load detection unit 121, transfer rollers 122, a document position detection unit 123, a white roller 124, and a document reader 125. In FIG. 2, the loaded document is shown in bold solid line, and the document transfer path is shown in one-dot chain line.

The document load detection unit 121 is a sensor for detecting whether a document is loaded in a paper loader, such as a paper-supply cassette. In the embodiment of the present invention, if the image-scanning unit 120 has a sheet-feed scanning function and an automatic paper feeder, the document load detection unit 121 detects whether plural documents are loaded in the document loader (not shown).

If a document load detection signal is received from the document load detection unit 121, at least one or more transfer rollers 122 pick up the loaded document under the control of the control unit 170, which will be described in more detail below, and transfer the document to an established reference position along the document transfer path. The established reference position is a position where the white roller 124, which will also be described in more detail below, can pick up a loaded document while rotating.

The document position detection unit 123 is a sensor for detecting whether a document has reached the established reference position. After receiving a signal from the document position detection unit 123 notifying the control unit 170 that a document has reached the established reference position, the control unit 170 stops the driving of at least one or more transfer rollers 122, and then drives the white roller 124.

The white roller 124 is disposed at a predetermined position on the document transfer path. The white roller 124 pushes a document toward the document reader 125, which will be described later in more detail, in order for the loaded document to be clearly read out.

The document reader 125 is an image sensor for reading images, and is installed opposite to the white roller 124 at the lower end portion of the document transfer path. If the white roller 124 rotates by a predetermined unit angle to perform a line scan, the document reader 125 reads an image positioned on the upper end portion of the document reader 125.

The document reader 125 can be a contact image sensor (CIS) or a charge coupled device (CCD) image sensor. A detailed description of the CCD and CIS image sensors will be omitted since they are well-known to those skilled in the technical field of the present invention.

The CIS is a small image input device consisting of a light source, lens, sensor, and so on, that are components necessary for reading data recorded on a document. The CCD image sensor digitizes an image captured via components such as CCD chip, lens, glass, and so on.

The CIS has an advantage of a smaller size, a lighter weight, and requires less driving power as compared to the CCD image sensor, but images scanned by the CIS are lower in quality as compared to those scanned by the CCD image sensor.

FIG. 3 is a view for schematically showing the operation panel of FIG. 1. In FIG. 3, the operation panel 110 has the user input unit 112 and the display unit 114.

The user input unit 112 outputs to the control unit 170 a signal generated from a button selected by a user in order to enable the user to request a function supported by the image-forming apparatus 100. To do so, the user input unit 112 is provided with various operation buttons and a touch screen, which is incorporated into display unit 114.

The display unit 114, which can be an LCD in general, also displays the operation states of the image-forming apparatus 100 under the controls of the control unit 170. In an embodiment of the present invention, the user input unit 112 is provided with a scanning-pause button 112a.

If the scanning-pause button 112a is selected, a pause signal requesting a scanning pause is input to the control unit 170, and the control unit 170 with an input of the pause signal controls the image-scanning unit 120 to pause the document reader 125 from reading a document, and controls the transfer rollers 122 to exhaust the document along the transfer path. Further, the control unit 170 processes the partial image read until the scan pause button 112a was selected, and stores the processed partial image in the storage unit 130, or controls the print unit 140 to print the scanned partial image.

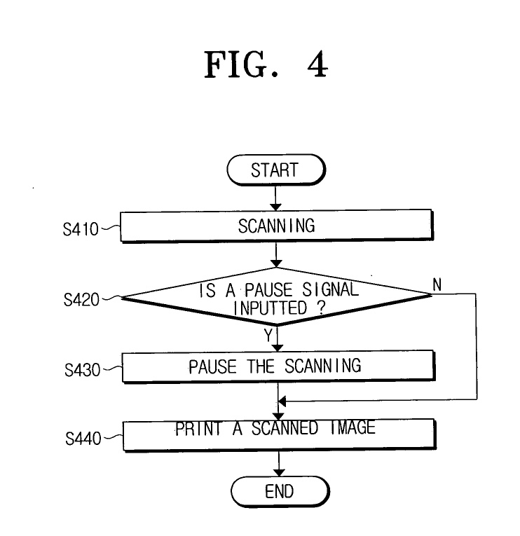

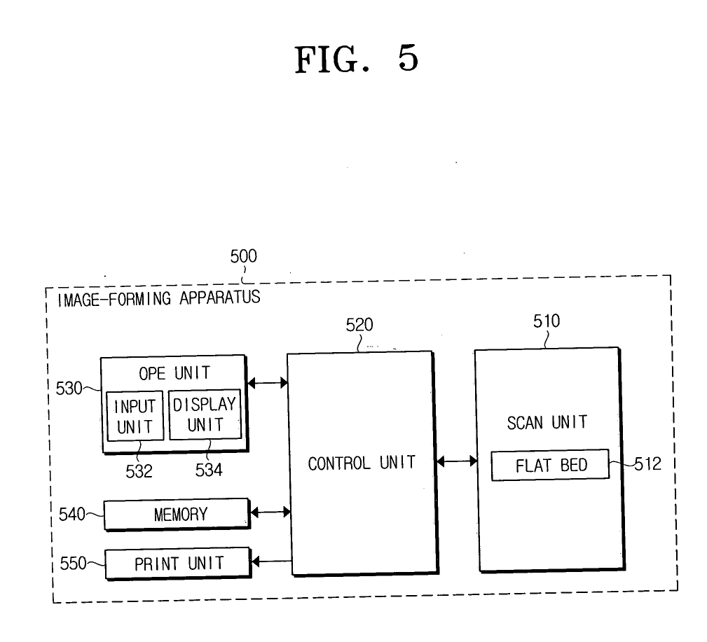

FIG. 4 is a flow chart showing a process for driving an image-forming apparatus having the image-scanning unit according to an embodiment of the present invention.

In FIG. 2 through FIG. 4, if the image-forming apparatus 100 is turned on, the document load detection unit 121 detects whether a document is loaded, and, if the document is detected to be loaded, the control unit 170 controls the transfer rollers 122 to transfer the document, controls the white roller 124 to rotate by a predetermined unit angle to perform a line scan, and controls the document reader 125 to scan the image positioned opposite to the white roller 124 by use of the CIS or CCD image sensor (S410).

A user directly checks by himself the document transferred to the position of the image sensor opposite to the white roller 124, and, if scanning is done up to the portion of the document the user wants, the user selects the scanning-pause button 112a to pause the scanning. If the scanning-pause button 112a is selected, a signal to pause the scanning, that is, a scanning-pause signal, is input to the control unit 170.

The control unit 170 checks whether the scanning-pause signal is input from the user input unit 112 (S420), and, if the scanning-pause signal is input, the control unit 170 controls the document reader 125 to pause the scanning of the document (S430). Further, the control unit 170 controls the transfer rollers 122 to exhaust the document along the transfer path.

Further, the control unit 170 processes into image data the image that was scanned until the scanning-pause signal is input, and stores the processed image data in the storage unit 130, or controls the print unit 140 to print the scanned image (S440).

The image-forming apparatus having a partial printing function and method therefor according to an embodiment of the present invention enables a user to check the transfer and scanning of a document, pause the scanning, and print a portion of the document scanned until paused. Thus, one can conveniently use the image-forming apparatus having an image-scanning unit of sheet feed-type without complicated manipulations or a number of hardware changes when printing a portion of a document.

Hereinafter, description will be made in detail of another embodiment of the present invention with reference to the accompanying drawings.

FIG. 5 is a block diagram for showing an image-forming apparatus 500 having a scanning-pause function according to another embodiment of the present invention. In FIG. 5, the image-forming apparatus 500 of the present invention has a scan unit 510 of flat-bed-type, a control unit 520, an OPE unit 530, a memory 540, and a print unit 550.

The image-forming apparatus 500 of the present invention can be a digital photocopier, a Multi-function printer (MFP) including a digital photocopier, a scanner, a photocopier of different type from the digital photocopier, and so on, in which the scan unit 510 to be described below scans and sends images to an image sensor such as CCD or contact image sensor (CIS) that converts the images into image data.

The scan unit 510 includes a flat bed 512, and scans documents and generates image data. The scan unit 510 is provided with an image sensor, such as CCD or CIS, and generates image data by scanning the document and performing a photoelectric conversion with respect to the light reflected from the document. The scan unit 510 scans a document on the flat bed 512 as the image sensor travels over a scanning section of a certain length.

The scan unit 510 can carry out the pause and resume operations under the control of the control unit 520. The ‘pause’ operation refers to a temporary stop of the image sensor of the scan unit 510 during the scanning of a document at a position at which a control signal is received. The ‘resume’ operation refers to restarting the scanning over the remaining scan section from the temporarily stopped position.

If the image-forming apparatus 500 is powered on, the control unit 520 controls the overall operation of the image-forming apparatus 500 under the control of a control program stored in the memory 540.

In more detail, the control unit 520 controls the scan unit 510 to scan a document. Further, the control unit 520 controls the scanning operation of the scan unit 510 according to a pause signal or a resume signal received from the OPE unit 530, which will be described later in more detail. Furthermore, the control unit 520 controls the scan unit 510 to pause the scanning operation at a temporary stop position established in advance by a user, and to resume the scanning operation after a predetermined period of time elapses after the pause. The control unit 520 sends to the print unit 550 image data read by the scan unit 510.

The OPE unit 530 preferably comprises an input unit 532 and a display unit 534. The input unit 532 has various function buttons supporting the input of characters and/or numbers. The input unit 532 inputs a command for the pause or the resume operation, and generates a pause signal or a resume signal, accordingly. To do this, a pause button or a resume button can be used for the generation of the pause or resume signal, or one button can be used for the generation of the two different signals. Further, if a user presets a temporary stop position, the input unit 532 inputs a preset signal therefor.

If a user presets a pause, the display unit 534 displays the pause in order for the user to establish the preset of the pause. In the simplest way, the user can use the scale shown on the flat bed 512 of the scan unit 510. Further, the control unit 520 controls the display unit 534 to display the operations of the image-forming apparatus 500 to the user. To do this, the display unit 534 can be provided with the liquid display device (LCD) or another suitable display device.

The memory 540 stores image data and information regarding a pause position preset by a user.

The print unit 550 prints on sheets of paper images corresponding to the image data transferred through the control unit 520. In the case of a scanner, the image data can be output to a computer monitor.

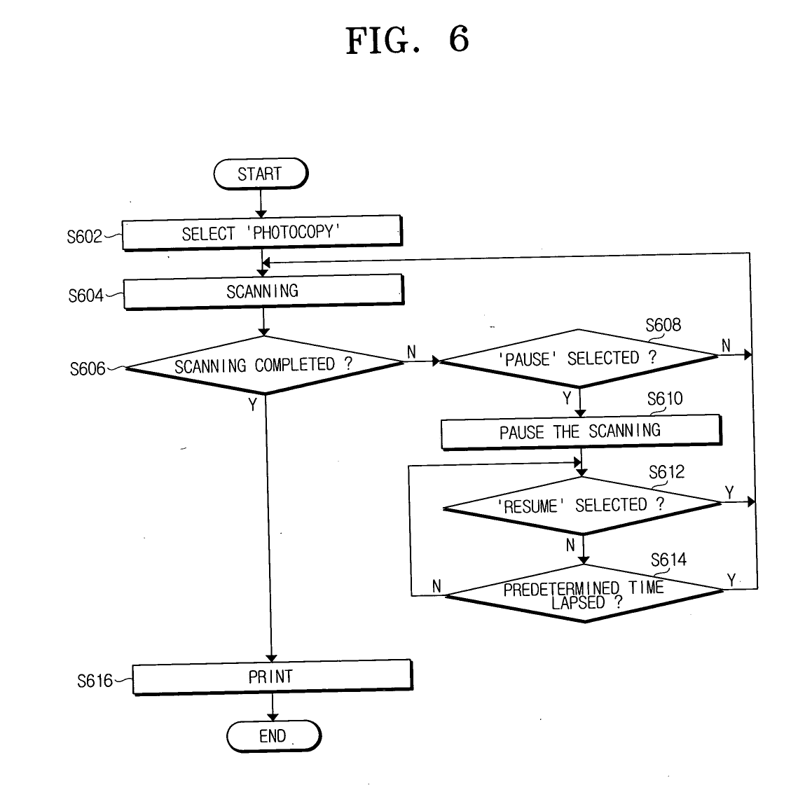

FIG. 6 is a flow chart of the pause operation during the scanning of the image-forming apparatus 500 according to an embodiment of the present invention. Hereinafter, a description will be made on the operations of the image-forming apparatus 500 having a scanning-pause function according to an embodiment of the present invention with reference to FIG. 5 and FIG. 6.

First, a user loads a document on the flat bed 512 of the scan unit 510 and inputs a command for photocopying the document (S602).

The scan unit 510 of the image-forming apparatus 500 starts scanning the document (S604).

The scan unit 510 continues to scan the document until a pause signal from the input unit 532 is input by the user to the control unit 520 (S608) before completion of the scanning of the document is determined (S606).

Further, if the input unit 532 generates a pause signal, the control unit 520 reads in the pause signal. The control unit 520 controls the scan unit 510 to pause the scanning according to the pause signal. Further description will be made later of the scanning by the scanning-resume of the user after the scanning pause with reference to FIG. 3 (S610).

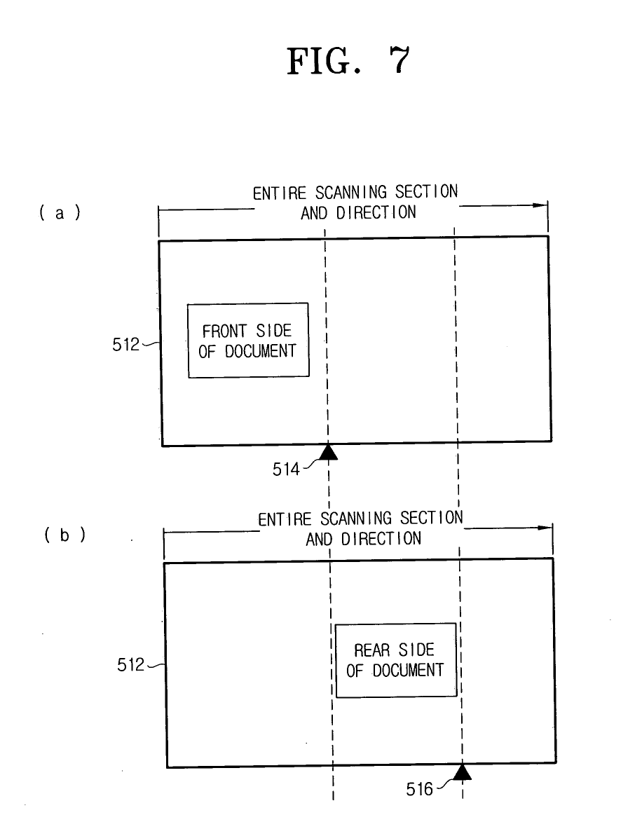

FIG. 7(a) and FIG. 7(b) are views showing the scanning operations by use of the scanning-pause function on the flat bed 512 according to an embodiment of the present invention. The elements having the same functions as those shown in FIG. 5 are given the same reference numerals, and the same description as above will be omitted. The arrowed solid line in FIG. 5 indicates the scanning direction and the solid line indicates the scanning area of the scan unit 510. The triangles indicate the scanning-pause positions, for example, scanning-pause-1 514 and scanning-pause-2 516, and the dotted lines are indication lines to serve as marks of the scanning-pause positions.

FIG. 7(a) shows that scanning is paused for the first time at the position 514 according to a scanning-pause signal and the front side of a document has been completely scanned. The control unit 520 waits until a scanning-resume signal is input from the input unit 532. Before inputting the scanning-resume signal, the user loads the document as shown in FIG. 7(b) in order for the rear side of the document to be scanned. After the user inputs the scanning-resume signal through the input unit 532, the control unit 520 controls the scan unit 510 paused at the position 514 to continue to scan (S612).

After resuming the scanning with the scanning-resume signal, the control unit 520 repeats steps S604 through S608, and then waits for another scanning-pause signal. If the scanning-pause signal is generated at the position 516 of FIG. 7(b) for the second time, the control unit 520 repeats steps S610 and S612, and then waits for the scanning-resume signal.

If the scanning-resume signal is not input within a predetermined period of time Td after the scanning is paused at step S610, the control unit 520 automatically scans the remaining portion, that is, the unscanned portion, of the document. Therefore, if there is no scanning-resume signal for the time Td after the scanning pause at the position 516, the control unit 520 controls the scan unit 510 to scan the rest of the scanning section (S614).

Preferably, the input unit 532 enables a user to set the time Td therethrough, and the display unit 534 displays information necessary for such a setting.

If the scanning is completed and image data is generated (S606), the control unit 520 reads the image data out of the scan unit 510 and transfers the read image data to the print unit 550. The print unit 550 prints on a sheet of paper the images corresponding to the transferred image data (S616).

According to a different embodiment, scanning-pause positions can be set in advance before a user starts photocopying (S602). Two or more positions can be set in advance. To do this, the display unit 534 can provide a user with information necessary for such settings. In the simplest way, a user can use the scale shown on the flat bed 512. Further, the user inputs position information using the input unit 532, which sends the scanning-pause position information to the control unit 520. The control unit 520 stores the scanning-pause position information in the memory 540, and controls the scan unit 510 based on the position information. The scanning-resume operations after the scanning pause is carried out at steps S612 and S614 as described above. The scanning-pause function of the image-forming apparatus 500 is performed according to the above method.

According to another different embodiment of the present invention, documents for printout can be loaded during such scanning operations, and, accordingly, basic editing can be made since documents can be newly loaded and printed on one sheet of paper without scanning two times or more.

As aforementioned, according to another embodiment of the present invention, the scan unit can temporarily stop, that is, pause during scanning, so that plural documents can be photocopied onto the same sheet of paper. In particular, the present invention is useful when a user intends to print the front and rear sides of a document on the same side of a sheet of paper. The embodiments of the present invention enable a user to print both sides of a document on the same side of a sheet of paper without performing a scanning job twice for each side. Further, embodiments of the present invention eliminate the preparation task of printing in advance the rear side of a document when a user wants both sides of the document to be printed on one side of a sheet of paper, thereby reducing user's effort and ink consumption of the print unit and paper consumption caused by unnecessary printing.

Furthermore, embodiments of the present invention can provide a basic edit function since plural documents can be printed on the same side of a sheet of paper during scanning by using the scanning-pause function several times.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. An image-forming apparatus having a pause function, comprising:
an image-scanning unit for scanning a loaded document;
a pause button for inputting a pause signal requesting to pause the scanning;
a control unit for determining whether the pause signal has been input, for controlling the image-scanning unit to pause scanning operations if the pause signal has been input, and for processing a partial image of the document scanned until the scanning operations are paused; and
a storage unit for storing the partial image.

2. The image-forming apparatus as claimed in claim 1, further comprising a print unit for printing the partial image.

3. The image-forming apparatus as claimed in claim 1, wherein the pause button is provided on an operation panel of the image-forming apparatus.

4. The image-forming apparatus as claimed in claim 1, wherein the pause button is provided on the front side of the image-forming apparatus so that a user can easily select the button.

5. The image-forming apparatus as claimed in claim 1, wherein the image-scanning unit is sheet feed type.

6. A printing method for image-forming apparatuses having a pause function, comprising steps of:
scanning a loaded document;
determining whether a pause signal requesting to pause the scanning has been input;
pausing scanning operations if the pause signal has been input; and
processing and storing a partial image scanned until the resume signal is input.

7. The printing method as claimed in claim 6, further comprising a step of printing the processed partial image.

8. The printing method as claimed in claim 6, wherein the pause signal is input when a pause button is selected.

9. The printing method as claimed in claim 8, wherein the pause button is provided on an operation panel of the image-forming apparatus.

10. An image-forming apparatus having a pause function, comprising:
a scan unit for scanning a document for printout and generating image data;
a control unit for controlling pauses and the resuming of scanning operations of the scan unit and reading of the image data of the scan unit; and
a print unit for printing images corresponding to the image data transferred from the control unit.

11. The image-forming apparatus as claimed in claim 10, further comprising an input unit for inputting a pause signal requesting to pause the scanning operations of the scan unit and a resume signal requesting to scan the rest of a scanning section, wherein the control unit reads in the pause signal or the resume signal, and controls the scan unit to pause or resume the scanning operations according to the read pause or resume signal.

12. The image-forming apparatus as claimed in claim 11, wherein the control unit controls the scan unit to pause at predetermined positions over an entire scanning area, and, if the resume signal is input, controls the scan unit to resume scanning remaining scan sections.

13. The image-forming apparatus as claimed in claim 10, wherein the control unit controls more than at least once the scan unit to pause at the predetermined positions over the entire scanning section and resume the remaining scans after a predetermined period of time lapses.

14. The image-forming apparatus as claimed in claim 13, wherein the input unit inputs predetermined periods of time for which the scan unit pauses and resumes the scanning operations.

15. A scanning method for image-forming apparatuses having a scan unit, comprising steps of:
pausing scanning operations of the scan unit during scanning; and
resuming the scanning operations as a user selects a resume option.

16. The scanning method as claimed in claim 15, wherein pause positions are preset by the user before the scanning operations.

17. The scanning method as claimed in claim 15, wherein pause positions are set by user's selections during the scanning operations.
